(19) United States
(12) Patent Application Publication
(10) Pub. No.: US 2015/0058802 A1
(43) Pub. Date: Feb. 26, 2015

(54) Graphical User Interface for Defining Relations Among Products and Services

(71) Applicant: HomerSoft sp. zo.o., Krakow (PL)

(72) Inventors: Hubert Turaj, Krakow (PL); Lukasz Czaczkowski, Rawa Mazowiecka (PL); Adam Gembala, Krakow (PL)

(73) Assignee: HomerSoft sp. zo.o., Krakow (PL)

(21) Appl. No.: 13/973,303

(22) Filed: Aug. 22, 2013

(51) Int. Cl. G06F 3/0482

(52) U.S. Cl. CPC G06F 3/0482
USPC 715/810

(57) ABSTRACT

A user interface is presented to a user via a computer system such as a tablet computer and enables users to create relations between selected products or services, such as those related to home automation. The graphical user interface (GUI) features a display that is analogous to that of a slot machine, with a touch-enabled screen that is operated with the user's fingers. The display icons of the GUI, arranged in rolls as on a slot machine's display, are representative of the products or services. The GUI presents the rolls of icons to the user, enabling the user to select an item in each roll and to define relations among the corresponding products or services. In this way, a sensor device associated with a first product/service can be linked to an actor device associated with a second product/service, so that the two devices are capable of telecommunicating with each other.

### FIELD OF THE INVENTION

The present invention relates to telecommunications in general, and, more particularly, to a graphical user interface for defining relations among products and services.

### BACKGROUND OF THE INVENTION

As part of a concept known as the “Internet of Things” (IoT), sensor devices communicate information about the environment around them to other devices. To enable this, the IoT comprises a network infrastructure that links physical and virtual objects through the use of data capture and communication capabilities. The network infrastructure of the IoT provides identification of specific objects, sensor monitoring, and connection capability.

The aforementioned features of the IoT serve as the basis for the development of cooperative services and applications, particularly those that are characterized by a high degree of autonomous data capture, event transfer, network connectivity, and interoperability. These applications include home automation; metering of power, gas, water and heating; monitoring of alarm systems, vending machines, medical devices and vital life functions; and tracking and tracing of vehicles and toll collection affecting those vehicles. In regard to home automation, services enabled in part by the IoT include sending a text when a doorbell rings, tweeting a pet owner when a pet's water bowl runs dry, and taking a photograph to be uploaded to a homeowner's Dropbox when motion is detected in the homeowner's garage, to name a few specific associations of sensors with services.

In a related development, the machine-to-machine (M2M) device, software, network and service market is expected to grow rapidly worldwide in the next few years. According to the Cisco Internet Business Solutions Group's (IBSG) April 2011 data, there were about 12.5 billion objects connected to the Internet in 2010 and there will be an estimated 50 billion connected devices by 2020. Key factors that are responsible for such rapid growth of connectivity include the dropping cost of access to the public mobile data network, and of access to wireless data networks in general, and the continually increasing capabilities of these networks.

As the number of connectable devices grows, so does the need to manage the connections between such devices more effectively.

### SUMMARY OF THE INVENTION

The present invention enables users to create relations between selected products or services, via a user interface and based on cause-and-effect rules. The products or services for which relations can be created are from fields such as home automation, Internet services, and any other situation in which a cause-and-effect relation may be applied.

In accordance with an illustrative embodiment of the present invention, a user interface is presented to a user via a computer system such as a tablet computer. The user interface comprises a graphical user interface (GUI) as part of a computer software application. The GUI disclosed herein features a display that is analogous to that of a slot machine, with a touch-enabled screen that is operated with the user's fingers. The GUI has scrollable, dynamic “rolls,” similar to those of a slot machine and in the form of vertical or horizontal “stripes” of information, which in this context are made up of display icons. These display icons are items that are representative of sensor and actor devices, or of products and/or services that have associated sensor or actor devices.

The user interface presents to the user two rolls, each roll having a displayable series of items. The first roll is a displayable first series of items, including one or more displayed items, and is situated in a display region on a first side (e.g., left side) of the user display. The second roll is a displayable second series of items, including one or more displayed items, and is situated in a display region on a second side (e.g., right side) of the user display. In some embodiments of the present invention, the first series of items is made up of a series of icons that represent “causes” and the second series of items is made up of a series of icons that represent “effects.”

The computer system of the illustrative embodiment presents the rolls of the user interface to the user, in order to enable the user to navigate through the relation management system, to select items and to define relations. A “relation” in this context is an association or a connection between two or more items that are representative of devices or of products and/or services. For example and without limitation, a sensor device associated with a first product or service can be linked to an actor device associated with a second product or service, so that the two devices are configured to telecommunicate with each other.

In a first variation of the illustrative embodiment of the present invention, the icons in the first roll directly represent sensor devices such as, but not limited to, the following: “Thermometer”, “Hygrometer”, “Anemometer”, “Motion Detector”, “Email Server”, and “Light Switch”. The icons in the second roll directly represent actor devices such as, but not limited to, the following: “Light Bulb”, “Heater”, “Air Conditioner”, “Media Player”, “Outgoing-Email Server”, and “Outgoing-SMS Text Server”.

For example, the user can select the “Motion Detector” sensor device as a cause and the “Media Player” actor device as an effect, and can then further define the relationship by specifying that detecting motion in a particular place will activate the playing of a particular music track, in a particular room at home and at a particular time and day. In this case, the cause is the detection of motion, as detected by the motion detector as the sensor device, and the effect is the playing of the music, as implemented by the media player as the actor device.

In a second variation of the illustrative embodiment of the present invention, and at a higher level of abstraction, the icons in the first roll represent products and services such as, but not limited to, the following: Evernote™, Google Latitude™, Twitter™, Gmail™, Belkin Motion™ sensor, and Facebook™. The icons in the second roll represent products and services such as, but not limited to, the following: Belkin Switch™ plug, Thermostat—Nest™, Scenes—Philips Hue™, Email Alert, and SMS Alert.

For example, the user can select “Gmail” as a cause and “Scenes—Philips Hue” as an effect, and can then further define the relationship by specifying that receiving a particular email on the user's Gmail account will activate the selected Hue scene (e.g., “stars pallet”) as a room-lighting effect in a particular room at home, at a particular time and day. In this case, the cause is the arrival of the incoming email, as detected by the user's Gmail account as the “sensor,” and the effect is the activation of the selected Hue scene, as implemented by the Philips Hue Lighting product as the “actor.”

In some embodiments of the present invention, the relation between the cause and effect is defined and previewed in the display region in the middle of the user interface—that is, between the selected cause and selected effect. In having this arrangement, the disclosed GUI reflects graphically and spatially the nature of the relation, in that the settings and relation “happen” between the cause and the effect.

The disclosed graphical user interface is advantageous, in that it enables easy and intuitive navigation, is responsive, maps real-world relations, and has increased usability. Moreover, in the embodiment of the invention operating at the products/services level, the need for a user to have to configure relations directly at the device level is reduced or eliminated.

A first embodiment of the present invention comprises: displaying at least one item in a displayable first series of items, on a display; detecting a selection of a first item from the first series of items; displaying at least one item in a displayable second series of items, on the display, wherein the second series of items is based on the selected first item; detecting a selection of a second item from the second series of items; and transmitting a signal for linking a) a first device represented by the selected first item and b) a second device represented by the selected second item, with each other, based on the detecting of: i) the selection of the first item, and ii) the selection of the second item; wherein the selected first and second items being in spatial alignment with each other on the display provides an indication of the linking of the first and second devices.

A second embodiment of the present invention comprises: a display for: i) displaying at least one item in a displayable first series of items, and ii) displaying at least one item in a displayable second series of items, wherein the second series of items is based on a first item being selected; a processor for: i) detecting the selection of the first item from the first series of items, ii) detecting a selection of the second item from the second series of items; and a transmitter for: i) transmitting a signal for linking a first device represented by the selected first item and a second device represented by the selected second item, with each other, based on the detecting of: a) the selection of the first item, and b) the selection of the second item, wherein the selected first and second items being in spatial alignment with each other on the display provides an indication of the linking of the first and second devices.

A third embodiment of the present invention comprises: displaying at least one cause in a displayable series of causes, on a display; detecting a selection of a cause from the series of causes; displaying at least one effect in a displayable series of effects, on the display, wherein the series of effects is based on the selected cause; detecting a selection of an effect from the series of effects; and transmitting a signal for linking a) a first device that is capable of monitoring for the cause selected and b) a second device that is capable of implementing the effect selected, with each other, such that the selected effect is brought about when the selected cause occurs, wherein the linking is based on the detecting of: i) the selection of the cause, and ii) the selection of the effect.

The foregoing summary provides a few embodiments of the present invention; additional embodiments are depicted in the appended drawings, the following detailed description, and the claims.

### BRIEF DESCRIPTION OF THE DRAWINGS

FIG. 1 depicts telecommunications system 100, in accordance with the illustrative embodiment of the present invention.

FIG. 2 depicts salient components of computer system 101, in accordance with the illustrative embodiment.

FIG. 3A depicts an example of sensors associated with one or more causation systems 104 and of actors associated with one or more affected systems 105, in accordance with the illustrative embodiment of the present invention.

FIG. 3B depicts user interface 301 for computer system 101, featuring sensor devices and actor devices represented on the display.

FIG. 3C depicts user interface 301 for computer system 101, featuring products and/or services represented on the display.

FIG. 4 depicts a flowchart of method 400, which comprises salient tasks performed by computer system 101, in accordance with the illustrative embodiment of the present invention.

FIG. 5 depicts a flowchart of the subtasks that constitute task 410.

FIG. 6 depicts an example of detecting that an item representing a cause has been moved into a display region of user interface 301.

FIG. 7 depicts a flowchart of the subtasks that constitute task 420.

FIG. 8 depicts an example of detecting that an item representing an effect has been moved into a display region of user interface 301.

FIG. 9 depicts a flowchart of the subtasks that constitute task 435.

FIG. 10 depicts an example of first device 1001 and second device 1002 having been linked to each other.

### DETAILED DESCRIPTION

To facilitate explanation and understanding of the present invention, the following description sets forth several details. However, it will be clear to those having ordinary skill in the art, after reading the present disclosure, that the present invention may be practiced without these specific details, or with an equivalent solution or configuration. Furthermore, some structures, devices, and operations that are well-known in the art are depicted in block diagram form in the accompanying figures in order to keep salient aspects of the present invention from being unnecessarily obscured.

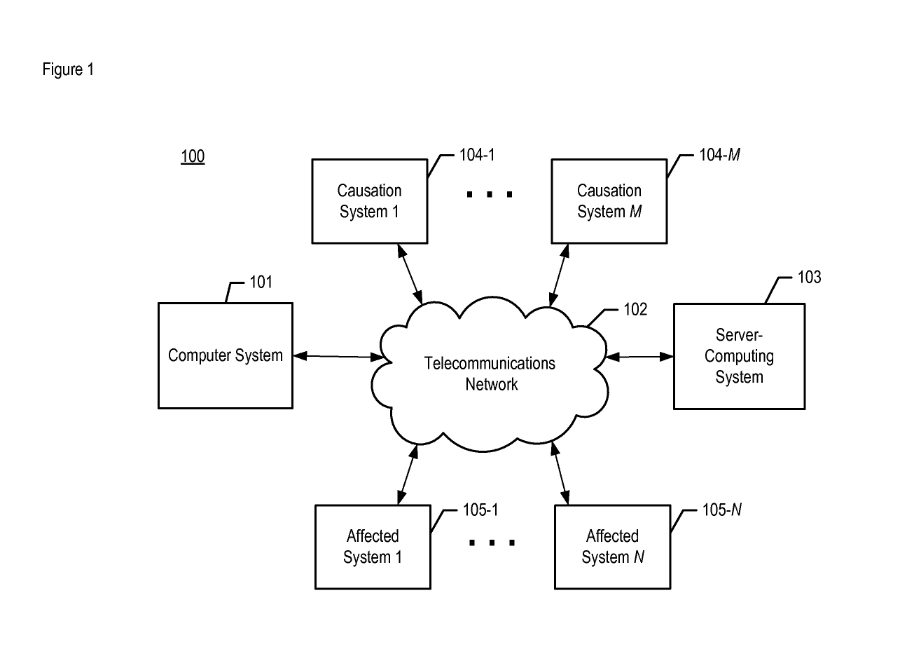

FIG. 1 depicts telecommunications system 100, in accordance with the illustrative embodiment of the present invention. System 100 comprises: computer system 101; telecommunications network 102; server computing system 103; causation systems 104-1 through 104-M, wherein M is a positive integer; and affected systems 105-1 through 105-N, wherein N is a positive integer. The aforementioned elements are interconnected as shown.

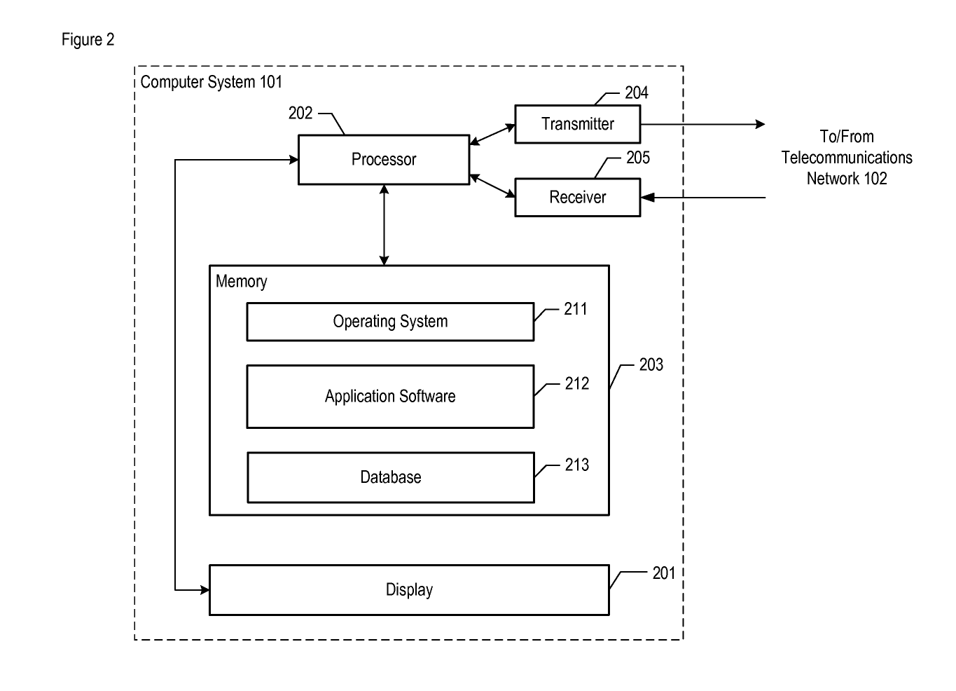

Computer system 101 is a computer that comprises memory, processing components, and communication components, as described in more detail in FIG. 2. System 101 is illustratively a tablet computer. Computer system 101 executes and coordinates the salient tasks of telecommunications system 100, in accordance with the illustrative embodiment of the present invention. For example, computer system 100 displays items that can be selected by a user, detects selections of those items, and, working in tandem with server computing system 103, links one or more causation systems 104-1 through 104-M with one or more affected systems 105-1 through 105-N.

Although telecommunications system 100 as depicted in FIG. 1 comprises only one computer system 101, it will be clear to those skilled in the art, after reading this disclosure, how to make and use alternative embodiments of the present invention that comprise any number of computer systems.

Telecommunications network 102 comprises a collection of links and nodes that enable telecommunication between devices, in well-known fashion. Telecommunications network 102 provides the elements of system 100 with connectivity to one other. In some embodiments of the present invention, telecommunications network 102 is the Internet; in some other embodiments of the present invention, network 102 is the Public Switched Telephone Network (PSTN); in still some other embodiments of the present invention, network 102 is a private data network. It will be clear to those with ordinary skill in the art, after reading this disclosure, that in some embodiments of the present invention network 102 can comprise one or more of the above-mentioned networks and/or other telecommunications networks, without limitation. Furthermore, it will be clear to those will ordinary skill in the art, after reading this disclosure, that telecommunications network 102 can comprise elements that are capable of wired and/or wireless communication, without limitation.

Server computing system 103 is a collection of software and hardware that responds to requests across telecommunications system 100 to provide network services. System 103 comprises one or more computers having non-transitory memory, processing components, and communication components. Server computing system 103 interacts with computer system 101, in particular, to link one or more causation systems 104-1 through 104-M with one or more affected systems 105-1 through 105-N. In some embodiments, system 103 enables cloud computing, as is known in the art, in which applications and/or data that could be stored and/or processed at computer system 101 are stored and/or processed at server computing system 103.

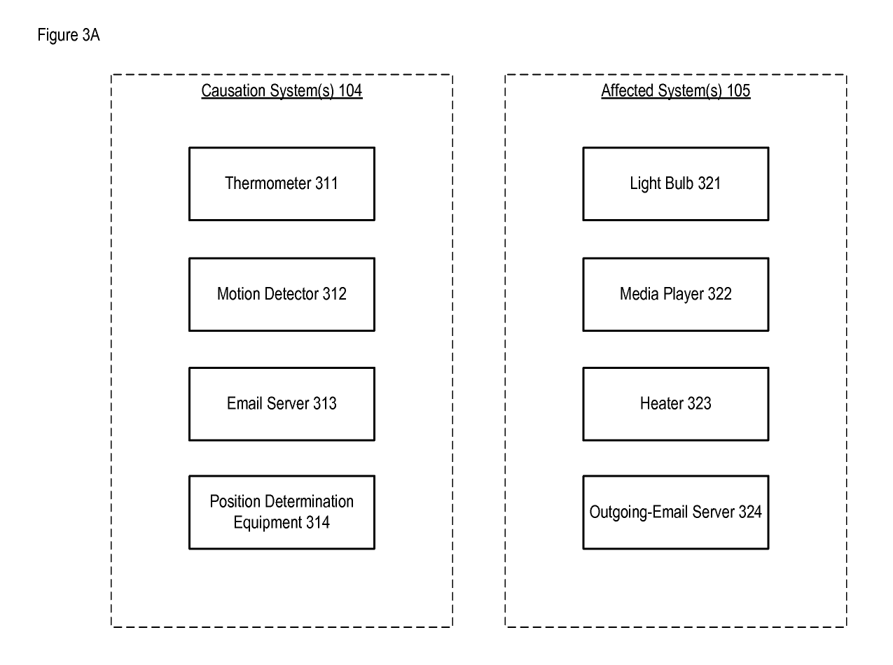

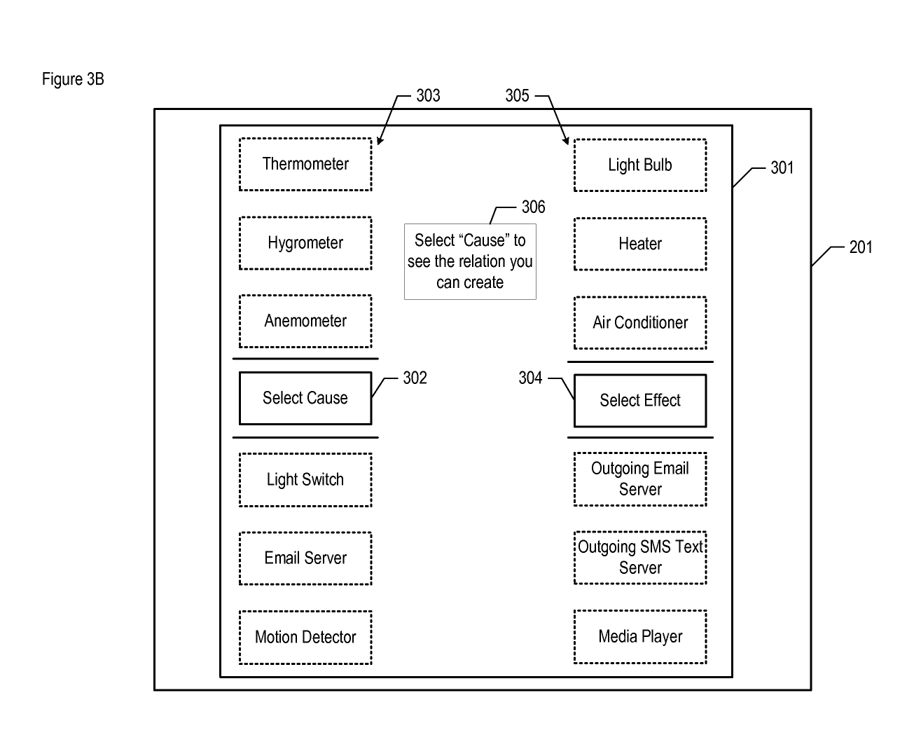

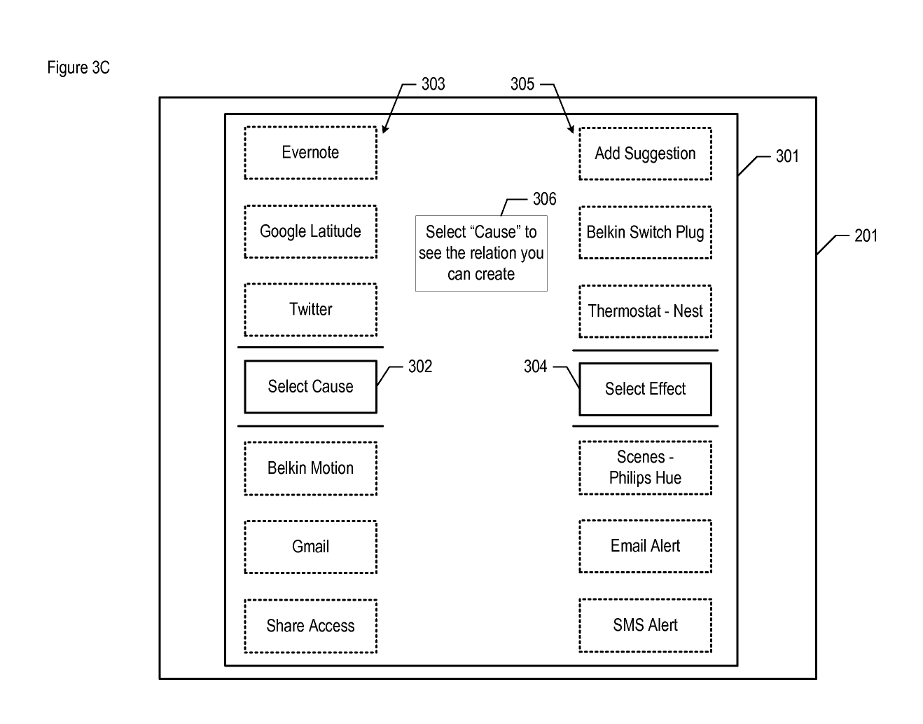

Causation system 104-m, wherein m is equal to 1 through M, inclusive, is capable of causing something to occur, as will be discussed in detail below. In accordance with the illustrative embodiment, each causation system 104-m comprises one or more sensors, wherein each sensor gathers information about the environment that is accessible by the causation system. Sensors that can be associated with causation systems 104 are described below and in FIG. 3A.

Affected system 105-n, wherein n is equal to 1 through N, inclusive, is capable of doing something in the course of being affected by one or more causes, as will be discussed in detail below. In accordance with the illustrative embodiment, each affected system 105-n comprises one or more actors, wherein each actor takes decisions that are based on one or more causes, as sensed by one or more causation systems 104-m, and performs appropriate actions upon the actor's environment. Each actor acts upon its environment in well-known fashion. Actors that can be associated with affected systems 105 are described below and in FIG. 3A.

FIG. 2 depicts salient components of computer system 101 according to the illustrative embodiment. Computer system 101 comprises: display 201, processor 202, memory 203, transmitter 204, and receiver 205. Computer system 101 is an apparatus that comprises the hardware and software necessary to perform the methods and operations described below and in the accompanying figures.

In accordance with the illustrative embodiment, computer system 101 is mobile and telecommunicates wirelessly. It will clear to those skilled in the art, however, after reading the present disclosure, how to make use and use various embodiments of the present invention in which computer system 101 operates primarily or solely at a fixed position, or is connected via physical media (e.g., cable, wire, etc.) to network 102, or both.

Computer system 101 is illustratively a tablet computer with at least packet data capability provided and supported by network 102. It will be clear to those skilled in the art, however, after reading the present disclosure, how to make and use alternative embodiments where computer system 101 is a desktop, laptop, hand-held computer, smartphone, cell phone, personal digital assistant (PDA), dedicated media player, consumer electronic device, wearable computer, smartwatch, smartglasses (e.g., a Google Glasses™ platform), specialized remote-control unit, other type of personal computer system, other computing device, or any combination thereof, for example and without limitation. Computer system 101 is capable of and configured to, for example and without limitation:
receive signals from server computing system 103, such as information related to some or all of causation systems 104-1 through 104-M and some or all of affected systems 105-1 through 105-N, and
transmit signals to server computing system 103, such as commands related to linking some or all of causation systems 104-1 through 104-M and some or all of affected systems 105-1 through 105-N, to one another.

Display 201 is a component that enables computer system 101 to present a user interface to a user according to the illustrative embodiment. Display 201 is well known in the art. In accordance with the illustrative embodiment, display 201 is built into the same enclosure of computer system 101 that also houses system 101's other salient components. In some alternative embodiments of the present invention, display 201 is housed in a physical enclosure separate from the other components depicted in FIG. 2.

Computer system 101 comprises an interactive function associated with display 201 such that display 201 is a touch-screen that receives user input—for example, via touching or stroking the surface of display 201. However, it will be clear to those skilled in the art, after reading the present disclosure, how to make and use alternative embodiments wherein the interactivity with display 201 is accomplished in a different way, e.g., stylus, mouse, keyboard, knob (i.e., physical turn-knob or otherwise), etc. The functionality of the user interface and its presentation scheme is described in more detail below and in the accompanying figures.

Processor 202 is a processing device such as a microprocessor that is well known in the art. Processor 202 is configured such that, when operating in conjunction with the other components of computer system 101, processor 202 executes software, processes data, and telecommunicates according to the operations described herein.

Memory 203 is non-transitory and non-volatile computer storage memory technology that is well known in the art (e.g., flash memory, etc.). Memory 203 stores operating system 211, application software 212, and database 213. Operating system 211 is a collection of software that manages, in well-known fashion, computer system 101's hardware resources and provides common services for computer programs, such as those that constitute application software 212.

The specialized application software 212 that is executed by processor 201 according to the illustrative embodiment is illustratively denominated the “relation management logic.” The relation management logic enables computer system 101 to perform the operations of method 400. It should be noted that in some configurations where computer system 101 collaborates with server computing system 103, system 103 also comprises and executes some elements of the relation control logic, for example, when system 103 performs certain operations in response to data received from computer system 101.

Database 213 illustratively comprises: mappings of display icons to causation systems and affected systems, mappings of causation systems to corresponding sensor devices, mappings of affected systems to corresponding actor devices, established links between sensor devices and actor devices, and other data, records, results, lists, associations, indicators, whether of an intermediate nature, final results, or archival.

It will be clear to those having ordinary skill in the art how to make and use alternative embodiments that comprise more than one memory 203; or comprise subdivided segments of memory 203; or comprise a plurality of memory technologies that collectively store operating system 211, application software 212, and database 213.

Transmitter 204 is a component that enables computer system 101 to telecommunicate with other components and systems by transmitting signals thereto. For example, transmitter 204 enables telecommunication pathways to server-computing system 103, causation systems 104-1 through 104-M, and affected systems 105-1 through 105-N, for example and without limitation. Transmitter 204 is well known in the art.

Receiver 205 is a component that enables computer system 101 to telecommunicate with other components and systems by receiving signals therefrom. For example, receiver 205 enables telecommunication pathways from server-computing system 103, causation systems 104-1 through 104-M, and affected systems 105-1 through 105-N, for example and without limitation. Receiver 205 is well known in the art.

It will be clear to those skilled in the art, after reading the present disclosure, that in some alternative embodiments the hardware platform of computer system 101 can be embodied as a multi-processor platform, as a sub-component of a larger computing platform, as a virtual computing element, or in some other computing environment—all within the scope of the present invention. In any event, it will be clear to those skilled in the art, after reading the present disclosure, how to make and use computer system 101.

FIG. 3A depicts an example of sensors associated with one or more causation systems 104 and of actors associated with one or more affected systems 105, in accordance with the illustrative embodiment of the present invention.

One or more sensors are associated with each causation system 104-m. Each sensor gathers information about the environment that is accessible by the causation system. In some embodiments, a sensor associated with causation system 104-m monitors a particular physical condition in well-known fashion. A sensor associated with causation system 104-m senses a change in the condition being monitored. For example and without limitation, the condition being monitored can be:
i. temperature,
ii. humidity,
iii. lighting level,
iv. wind speed or direction,
v. motion being present,
vi. a switch being opened or closed,
vii. flow of email,
viii. flow of text messages,
ix. arriving invitations (e.g., to Facebook, to LinkedIn, etc.),
x. arriving tweets,
xi. geolocations of one or more persons or objects.

As those who are skilled in the art will appreciate, after reading this disclosure, the sensor associated with causation system 104-m can be in a variety of forms, such as a thermometer 311, a motion detector 312, an email server 313, a position determination equipment (PDE) 314, and so on.

Likewise, one or more actors are associated with each affected system 105-n. Each actor performs appropriate actions upon the actor's environment, based either on commands received from another entity making decisions (e.g., a separate middleware decision layer, etc.) or on decisions made by actor itself, or both. The decisions that are made (i.e., by the other entity and/or by the actor itself) are based on one or more causes, as sensed by sensors in one or more causation systems 104-m. Each actor acts upon its environment in well-known fashion. In some embodiments, an actor is or comprises an actuator, as is known in the art. An actor associated with affected system 105-n is capable of receiving, transmitting, processing, and/or relaying data, as well as being able to affect a condition, physical or otherwise, in its environment. For example and without limitation, the condition being affected can be:
i. lighting, which can be adjusted (e.g., turning on or off, changing color or mood, displaying a picture or pattern, etc.),
ii. sound, which can be adjusted (e.g., increasing or decreasing volume, changing playlist or mood, etc.),
iii. room climate, which can be controlled (e.g., increasing or decreasing temperature, humidity, air fragrance, etc.),
iv. an alert, which can be generated (e.g., of an email, of an SMS message, etc.),
v. monitoring by a camera, which can be panned or tilted.

As those who are skilled in the art will appreciate, after reading this disclosure, the actor associated with affected system 105-n can be in a variety of forms, such as a light bulb 321 as part of a lighting system, a media player 322 as part of an audio/video system, a heater 323 as part of an environment control system, an outgoing-email server 324 as part of a messaging system, an actor in a water sprinkler system, a robot or robotic arm, a pan/tilt camera, a switch, a motor, a servo mechanism, and so on.

In some embodiments of the present invention, an actor can also be considered a sensor or can be directly associated with a sensor, in the case of one or more of the actors. For example, a state of a light bulb (i.e., “on” or “off”) can be tested and subsequent actions can be defined. As another example, an email sent as an “effect” of one rule can be a “cause” of one or more subsequently defined actions.

FIGS. 3B and 3C depict user interface 301 for computer system 101, in accordance with the illustrative embodiment of the present invention. User interface 301 is presented to the user via display 201 on computer system 101. User interface 301 comprises a graphical user interface (GUI) as part of a computer software application that is native or web-based. In some alternative embodiments of the present invention, the software application can be a different configuration such as an embedded display in a vending machine or a car computer configuration, for example and without limitation.

The depicted GUI appears and works as a slot machine, being operated with fingers on a touch-enabled screen. This slot-machine GUI has scrollable, dynamic “rolls” in the form of vertical or horizontal “stripes” of information, which in this context are display icons. These display icons are items that are representative of products or services, which have associated sensor devices or actor devices in some embodiments of the present invention. In some embodiments of the present invention, one or more of the display icons are directly representative of sensor devices or actor devices themselves.

User interface 301 presents to the user two rolls, each roll having a displayable series of items. The first roll is a displayable first series of items 303, including displayed item 302, and is situated in a display region on the left side of user interface 301, as depicted. The second roll is a displayable second series of items 305, including displayed item 304, and is situated in a display region on the right side of user interface 301, as depicted. First series 303 is made up of a series of icons representing “causes,” and second series 305 is made up of a series of icons representing “effects.”

Computer system 101 presents the rolls of user interface 301 to the user, in order to enable the user to navigate through the relation management system, to select items and to define relations. A relation in this context is an association or a connection between two or more items representative of products, services, and/or devices. For example, a sensor device (e.g., motion detector 312, etc.) can be linked to an actor device (e.g., media player 322, etc.), so that the two devices are capable of telecommunicating with each other or are, in fact, in communication with each other.

As illustrated specifically in FIG. 3B, user interface 301 depicts a leftmost roll of icons representing the following sensor devices recited on the interface as follows: “Thermometer”, “Hygrometer”, “Anemometer”, “Motion Detector”, “Email Server”, and “Light Switch”, as well as an initial prompt icon with the caption “Select Cause”. User interface 301 also depicts a rightmost roll of icons representing the following actor devices recited on the interface as follows: “Light Bulb”, “Heater”, “Air Conditioner”, “Media Player”, “Outgoing-Email Server”, and “Outgoing-SMS Text Server”, as well as an initial prompt icon with the caption “Select Effect”. User interface 301 further depicts caption 306 reciting “Select ‘Cause’ to see the relation you can create”, in order to prompt the user to select a cause from the left roll and an effect from the right roll.

For example, the user can select “Motion Detector” as a cause and “Media Player” as an effect, and can then further define the relationship by specifying that detecting motion in a particular place will activate the playing of a particular music track, in a particular room at home and at a particular time and day. In this case, the cause is the detection of motion, as detected by motion detector 312 as the sensor device, and the effect is the playing of the music, as implemented by media player 322 as the actor device.

In some other embodiments of the present invention, a sensor device can be associated with a first product or service, and an actor device can be associated with a second product or service. In this case, the user manages the establishment of the relation at a product/service level, which is a higher level of abstraction than the device level. This higher level of abstraction involving products and/or services is now discussed.

As illustrated specifically in FIG. 3C, user interface 301 depicts a leftmost roll of icons representing the following products or services, at least some of which being related to home automation, recited on the interface as follows: “Evernote™”, “Google Latitude™”, “Twitter™”, “Gmail™”, “Belkin Motion™” sensor, and “Share Access”, as well as an initial prompt icon with the caption “Select Cause”. User interface 301 also depicts a rightmost roll of icons representing the following products or services, at least some of which being related to home automation, recited on the interface as follows: “Belkin Switch™” plug, “Thermostat—Nest™”, “Scenes—Philips Hue™”, “Email Alert”, and “SMS Alert”, as well as an icon with the caption “Add Suggestion” and an initial prompt icon with the caption “Select Effect”. User interface 301 further depicts caption 306 reciting “Select ‘Cause’ and ‘Effect’”, in order to prompt the user to select a cause from the left roll and an effect from the right roll.

For example, the user can select “Gmail” as a cause and “Scenes—Philips Hue” as an effect, and can then further define the relationship by specifying that receiving a particular email on the user's Gmail account will activate the selected Hue scene (e.g., “stars pallet”) as a room-lighting effect in a particular room at home, at a particular time and day. In this case, the cause is the arrival of the incoming email, as detected by the user's Gmail account as the “sensor,” and the effect is the activation of the selected Hue scene, as implemented by the Philips Hue Lighting product as the “actor.” In this example, software within an incoming email server serves as the actual sensor device and a smart light bulb serves as the actual actor device.

Various alternative embodiments of user interface 301 are possible, as those who are skilled in the art will appreciate after reading the present disclosure. First, as depicted in FIGS. 3B and 3C, user interface 301 features two rolls, each roll having a displayable series of items. It will be clear to those skilled in the art, however, after reading the present disclosure, how to make and use alternative embodiments in which a different number of rolls constitute interface 301. Second, it will be clear to those skilled in the art, after reading the present disclosure, how to make and use alternative embodiments in which the rolls are displayed in different display regions on user interface 301 than depicted (e.g., across the top and bottom of the display area instead of down the left and right of the display area). Third, it will be clear to those skilled in the art, after reading the present disclosure, how to make and use alternative embodiments in which constructs other than rolls are used for displaying each displayable series of items (e.g., a “wheel” instead of a “strip”, etc.).

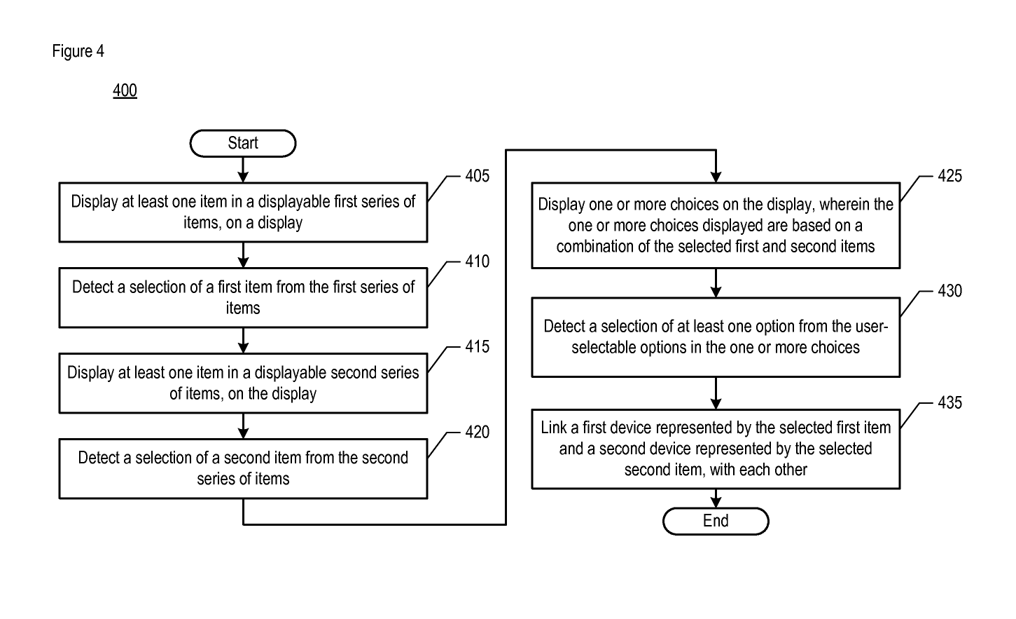

FIG. 4 and subsequent figures depict flowcharts of the salient tasks performed by computer system 101, in accordance with the illustrative embodiment of the present invention. The tasks performed by computer system 101 of the illustrative embodiment are depicted in the drawings as being performed in a particular order. It will, however, be clear to those skilled in the art, after reading this disclosure, that these operations can be performed in a different order than depicted or can be performed in a non-sequential order (e.g., in parallel, etc.). In some embodiments of the present invention, some or all of the depicted tasks might be combined or performed by different devices. For example, server-computing system 103 might perform at least some of the tasks that are depicted as being performed by computer system 101. In some embodiments of the present invention, some of the depicted tasks might be omitted.

FIG. 4 depicts a flowchart of method 400, which comprises salient tasks performed by computer system 101, in accordance with the illustrative embodiment of the present invention.

At task 405, computer system 101 displays at least one item in a displayable first series of items, on display 201. System 101 determines a set of items to display, out of all of the possible displayable items, based on predetermined criteria. For example, system 101 might display a set of items that is user-independent (e.g., a general default list), or system 101 might display a set of items that is user-specific (e.g., based a user attribute, based on a user demographic, based on a user behavioral pattern, based on what the user had previously selected as an effect, etc.). In some embodiments of the present invention, at least one item related to or representative of an advertisement is displayed, which can be user-independent or user-specific as well.

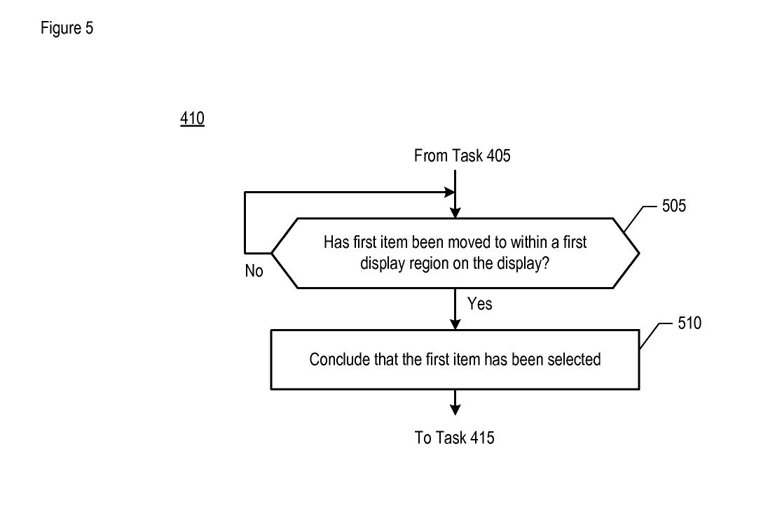

At task 410, computer system 101 detects a selection of an item from the first series of items. Task 410 is described below and in FIG. 5.

At task 415, computer system 101 displays at least one item in a displayable second series of items, on display 201. In accordance with the illustrative embodiment, system 101 determines which subset to display, out of all of the possible displayable items, based on the selected item detected at task 410. For example, system 101 might display a first subset of items to display based on a first selected item having been detected at task 410, whereas system 101 might display a second subset of items to display based on a second selected item having been detected at task 410, wherein the first and second subset might or might not have any items in common. In some embodiments of the present invention, at least one item related to or representative of an advertisement is displayed, based on the selected item detected at task 410.

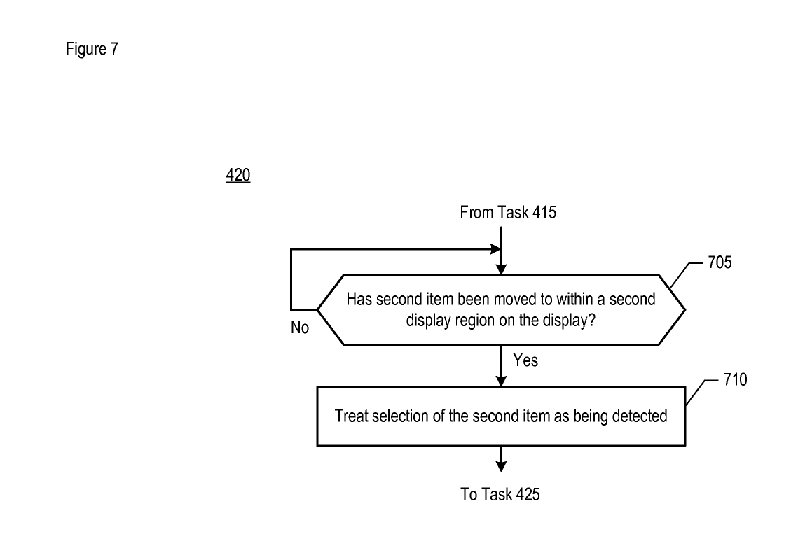

At task 420, computer system 101 detects a selection of an item from the second series of items. Task 420 is described below and in FIG. 7.

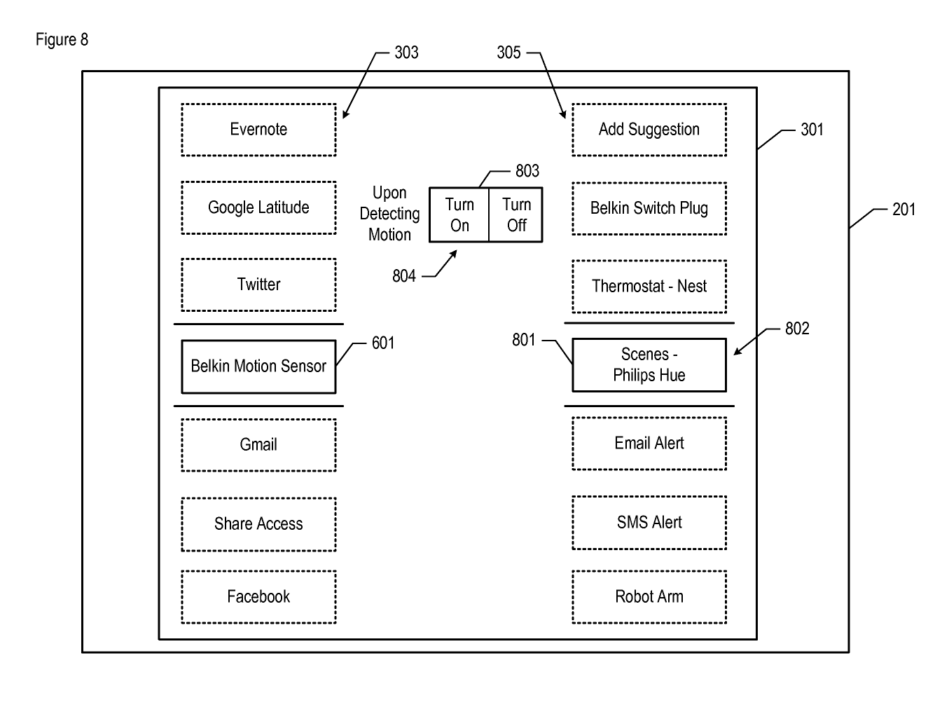

At task 425, computer system 101 optionally displays one or more choices as part of a user menu in a third region of the display. The choices displayed offer user-selectable options to the user and are based on a combination of the selected first and second items. In accordance with the illustrative embodiment, system 101 determines i) what information content to display as part the user menu or ii) whether to display any content at all, or both, based on the selected item detected at task 410 or on the selected item detected at task 420, either alone or in combination with each other. The user menu can include a set of options and/or conditions for the sensor; for example, a condition for a temperature sensor might be “falls below 10 degrees.” The user menu also can include a set of available actions for the actor; for example, an available action for a heater might be “turn on.” An example of the third region of the display is depicted in FIG. 8.

At task 430, computer system 101 detects, in well-known fashion, a selection of at least one option specifying one or more conditions, from the user-selectable options displayed at task 425. System 101 uses the selection of the option or options to define, at least in part, the relation between the selected first and second items and between their underlying devices.

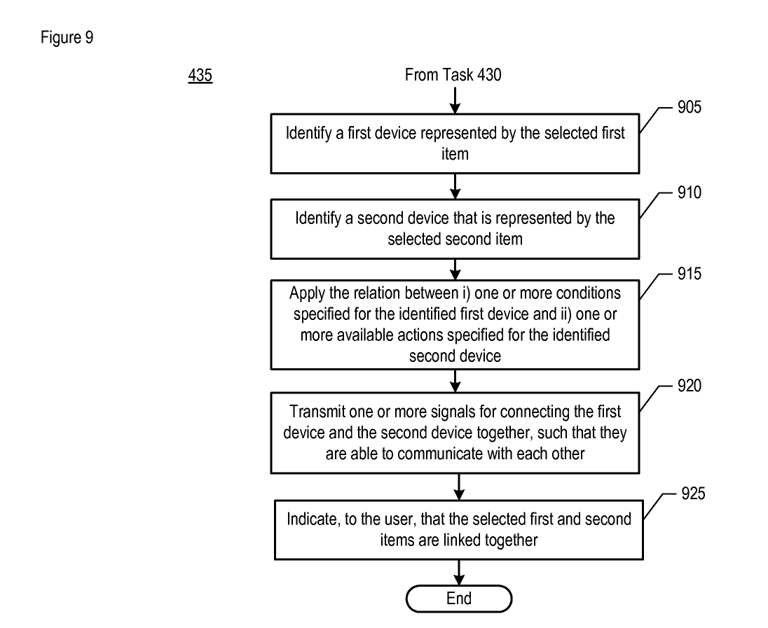

At task 435, computer system 101 links i) a first device that constitutes causation system 104-m and that is represented by the selected first item and ii) a second device that constitutes affected system 105-n and that is represented by the selected second item, with each other. Linking comprises one or both of i) applying the relation between the condition specified for the selected sensor and the action specified for the selected actor, and ii) establishing the connectivity between the selected sensor and actor. In accordance with the illustrative embodiment, the linking is based on i) the detecting at task 410 of the selection of the first item and ii) the detecting at task 420 of the selection of the second item. Task 435 is described below and in FIG. 9.

After task 435, computer system 101 returns to a processing state in which a user of user interface 301 is able to select a different pair of items of the purpose of linking together a different pair of devices.

FIG. 5 depicts a flowchart of the subtasks that constitute task 410, in accordance with the illustrative embodiment of the present invention.

At task 505, computer system 101 detects the selection of the first item as described at task 410. System 101 does this, at least in part, by determining whether the first item has been moved, by a user of display 201, to within a first display region of user interface 301, in well-known fashion.

At task 510, upon determining that the first item has been moved to within the first display region, computer system 101 concludes that the user has selected the first item.

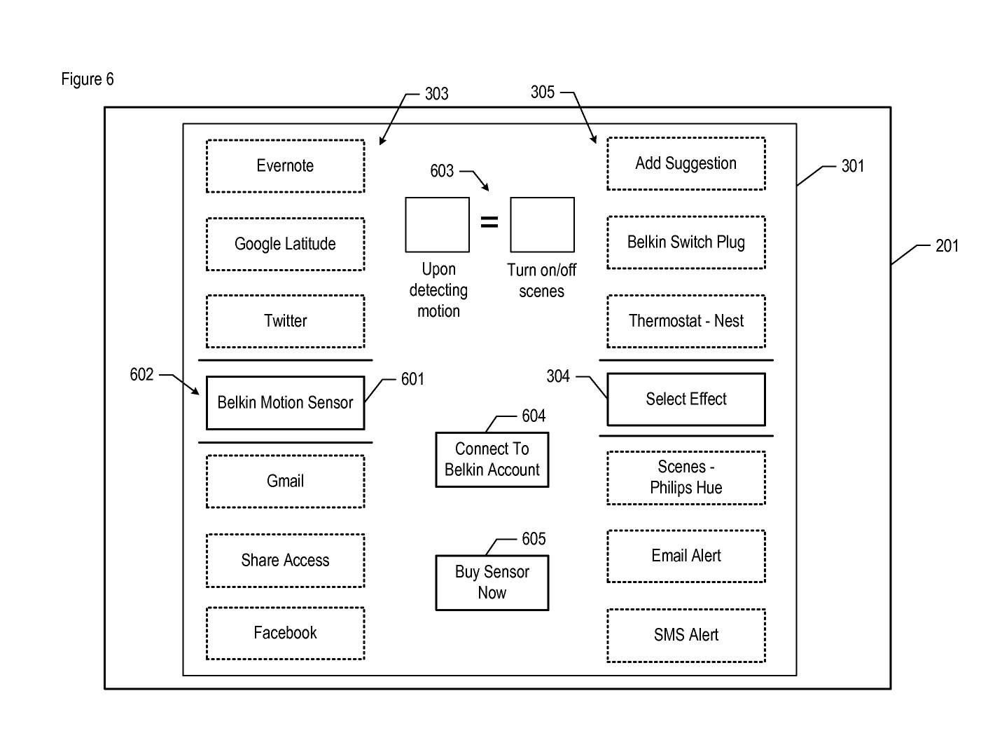

Consistent with tasks 505 and 510, FIG. 6 depicts an example of detecting that an item representing a cause has been moved into a display region of user interface 301. The leftmost roll of icons represents products or services similar to those in FIG. 3C. In some alternative embodiments of the present invention, however, the leftmost roll of icons represents sensor devices similar to those in FIG. 3B. In this example depicted in FIG. 6, the user has moved item 601, the “Belkin Motion Sensor” icon, into display region 602, by using his finger to roll first series 303 upwards. This also has the incidental effect of rolling a Facebook icon into view as an additional, relevant service that can be selected by the user. In this example, display region 602 is delineated to the user with horizontal lines immediately above and below the display region. Additionally, the candidate item being selected by the user is itself delineated differently than the other items in the series—in this case by blurring out or deemphasizing the other icons in the series, as shown by dotted rectangles instead of a solid rectangle. In some embodiments of the present invention, the candidate item and the other items can be distinguished from each other by differences in display intensity, differences in display sharpness, the display region occupied by the candidate item being emphasized differently, and so on.

Computer system 101 determines that the movement of item 601 into region 602, followed by the removal of the user's finger from the icon, has happened and, as a result, concludes that the user has selected Belkin Motion Sensor as a “cause.” In some embodiments of the present invention, computer system 101 then displays one or more captions and/or selection buttons that are relevant to the selected item, in the center of the display.

Computer system 101 then displays graphical and/or textual elements in display region 603, shown in FIG. 6, which is relevant to the selected cause item and to one or more candidate effect items that are not yet selected. These displayed elements represent sample, possible relations between the selected cause item and various candidate effect items. For example system 101, might present that it is possible to pair the selected Belkin Motion Sensor cause with the turning on or off of one or more Scenes as an effect.

Computer system 101 can also display other pertinent information that is contextual to the selected cause item. For example, system 101 displays login prompt 604 (i.e., “Connect to account”) for providing access to an account that is associated with the selected cause. As another example, system 101 displays advertising prompt 605 (i.e., “Buy product”) for advertising something about the selected cause.

FIG. 7 depicts a flowchart of the subtasks that constitute task 420, in accordance with the illustrative embodiment of the present invention.

At task 705, computer system 101 detects the selection of the second item as described at task 420. System 101 does this, at least in part, by determining whether the second item has been moved, by a user of display 201, to within a second display region of user interface 301, displayed on display 201, in well-known fashion.

At task 710, upon determining that the second item has been moved to within the second display region, computer system 101 concludes that the user has selected the second item.

Consistent with tasks 705 and 710, FIG. 8 depicts an example of detecting that an item representing an effect has been moved into a display region of user interface 301. The rightmost roll of icons represents products or services similar to those in FIG. 3C. In some alternative embodiments of the present invention, however, the rightmost roll of icons represents actor devices similar to those in FIG. 3B. In this example depicted in FIG. 8, the user has moved item 801, the “Scenes—Philips Hue” icon, into display region 802, by using his finger to roll seconds series 305 upwards. In this example, display region 802 is delineated to the user with horizontal lines immediately above and below the display region. Additionally, the candidate item being selected by the user is itself delineated differently than the other items in the series—in this case by blurring out or deemphasizing the other icons in the series, as shown by dotted rectangles instead of a solid rectangle.

Computer system 101 determines that the movement of item 801 into region 802, followed by the removal of the user's finger from the icon, has happened and, as a result, concludes that the user has selected Scenes—Philips Hue as an “effect.”

Computer system 101 then displays one or more choices as part of user menu 803 in display region 804, shown in FIG. 8, which is relevant to both the selected cause and selected effect items, as part of task 425 of FIG. 4. In this example, user menu 803 prompts the user to configure the relation between the selected Belkin Motion Sensor cause and the selected Scenes effect, depending on whether motion is detected by the sensor product. Specifically, the user may i) select an option to have the Scene turn on when motion is detected or ii) select an option to have the Scene turn off when motion is detected. Other user menu items relevant to this combination can include, for example and without limitation: a separate control to enable/not enable the scene when “Motion Detected”, a separate control to enable/not enable when “Motionless”, the “Response Time” applicable to the enabling event, and the days and times when each set of selected conditions applies.

In some embodiments of the present invention, the prompts in user menu 803 are based on one or more relations already established. For example, as previously discussed, an actor can be considered a sensor or can be directly associated with a sensor. For example, menu 803 can provide the option to test a state of a light bulb (i.e., “on” or “off”) and to define subsequent actions. As another example, menu 803 can provide the option to have an email, which was sent as an “effect” of one rule, be a “cause” of one or more subsequently defined actions. In other words, an effect or actor in a previously-created first relation can be configured via menu 803 as a cause or sensor in a second relation being created by the user.

FIG. 9 depicts a flowchart of the subtasks that constitute task 435, in accordance with the illustrative embodiment of the present invention. In some alternative embodiments, server-computing system 103 performs some or all of the depicted tasks related to linking a first device and a second device with each other, either alone or in tandem with computer system 101.

At task 905, computer system 101 identifies a first device that is represented by the selected first item. For example, a relationship between i) each icon in the first series and ii) one or more associated first devices, can be maintained in database 213 and accessed from the database by system 101.

At task 910, computer system 101 identifies a second device that is represented by the selected second item. For example, a relationship between i) each icon and the second series and ii) one or more associated second devices, can be maintained in database 213 and accessed from the database by system 101.

At task 915, computer system 101 applies the relation between i) one or more specified conditions, if any, for the selected sensor device and ii) one or more specified available actions, if any, for the selected actor device. These conditions are a part of the one or more options selected by the user and detected by system 101 at task 430. A purpose of this is to establish when a sensor device transmits a signal for an actor device, or when an actor device performs an appropriate action based on a signal transmitted by a sensor device, or both. For example, suppose that the specified condition for a motion sensor is “motion detected” and the specified action for a light bulb (actor) is “blink red five times”. In this case, computer system 101 transmits to one or more of server-computing system 103, causation system 104-m (wherein m corresponds to the selected sensor), and affected system 105-n (wherein n corresponds to the selected actor), information (e.g., one or more signals, one or more messages, one or more records, etc.) representing the relation of the light bulb blinking red five times when the motion sensor detects motion.

At task 920, computer system 101 connects logically the first device and the second device together, such that they are able to communicate with each other, in well-known fashion. For example, computer system 101 can access each device and transmit one or more signals that inform each device of i) the presence of the other device and ii) the relationship between each other. As another example, computer system 101 can transmit one or more signals to server-computing system 103, which in turn connects the first and second devices together.

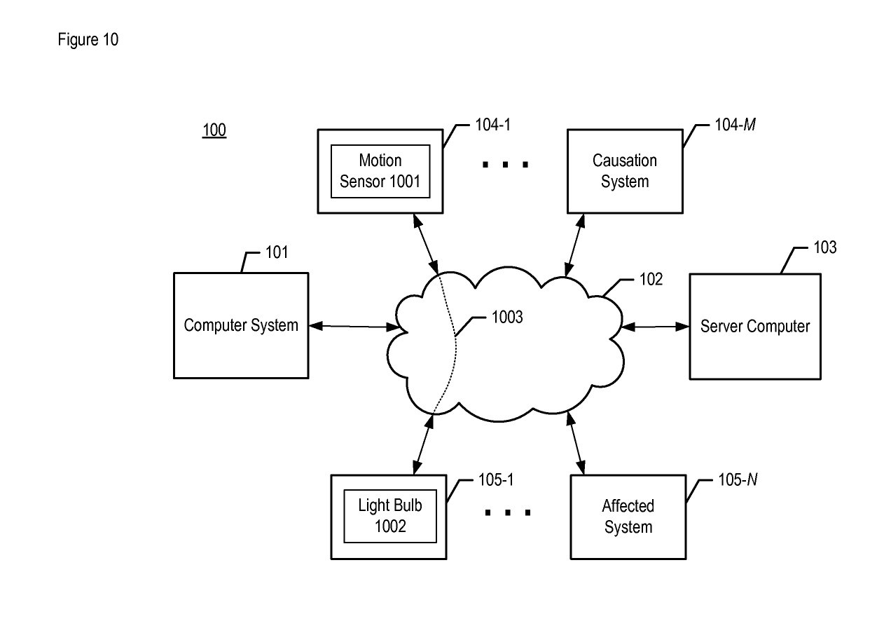

FIG. 10 depicts an example of a first device and a second device having been linked with each other. FIG. 10 comprises the same elements as shown in FIG. 1 and interconnected together in the same way. Additionally, FIG. 10 depicts a first device, motion sensor 1001 that is part of causation system 104-1, and a second device, light bulb 1002 that is part of effected system 105-1. Based on the user-created relation between the motion sensor product and the light bulb product, motion sensor 1001 will send one or more messages to light bulb 1002 via communication path 1003, in order to activate or change a scene in the configured environment.

At task 925, computer system 101 optionally indicates to the user that the selected first and second items are linked together, or the corresponding first and second devices are linked together, or both. The selected first and second items being in spatial alignment with each other on the display, in this case horizontally as shown in FIG. 8, possibly in combination with one or more additional cues (e.g., a user menu button having been pressed, etc.), indicates to the user the linking of the first and second devices with each other. In some other embodiments, the linking of the first and second devices is indicated in a different way.

It is to be understood that many variations of the invention can easily be devised by those skilled in the art after reading this disclosure and that the scope of the present invention is to be determined by the following claims.

What is claimed is:

1. A method comprising:
displaying at least one item in a displayable first series of items, on a display;
detecting a selection of a first item from the first series of items;
displaying at least one item in a displayable second series of items, on the display, wherein the second series of items is based on the selected first item;
detecting a selection of a second item from the second series of items; and
transmitting a signal for linking a) a first device represented by the selected first item and b) a second device represented by the selected second item, with each other, based on the detecting of:
i) the selection of the first item, and
ii) the selection of the second item;
wherein the selected first and second items being in spatial alignment with each other on the display provides an indication of the linking of the first and second devices.

2. The method of claim 1 wherein the linking comprises connecting the first device represented by the selected first item and the second device represented by the selected second item to each other, such that the first and second devices are able to communicate with each other.

3. The method of claim 2 wherein the first device is a sensor.

4. The method of claim 3 wherein the second device is an actor that is configured to perform an action based on a signal from the sensor.

5. The method of claim 1 wherein the displaying of the at least one item in the first series of items comprises displaying, on the display, a candidate item with a different emphasis than that of any other items in the first series that are displayed on the display.

6. The method of claim 1 wherein the detecting of the selection of the first item comprises determining whether the first item has been moved, by a user of the display, to within a first display region on the display.

7. The method of claim 6 wherein the detecting of the selection of the second item comprises determining whether the second item has been moved to within a second display region on the display, wherein the first and second display regions are in spatially aligned with each other in relation to the spatial dimensions of the display.

8. The method of claim 1 further comprising:
i) displaying one or more choices in a third region of the display, each choice in the one or more choices offering user-selectable options, wherein the one or more choices displayed are based on a combination of the selected first and second items; and
ii) detecting a selection of at least one option from the user-selectable options;
wherein the transmitting of the signal for linking is also based on the selection of the at least one option.

9. The method of claim 1 wherein the second series of items comprises at least one item that is representative of an advertisement that is based on the selected first item.

10. A system comprising:
a display for:
i) displaying at least one item in a displayable first series of items, and
ii) displaying at least one item in a displayable second series of items, wherein the second series of items is based on a first item being selected;
a processor for:
i) detecting the selection of the first item from the first series of items,
ii) detecting a selection of the second item from the second series of items; and
a transmitter for:
i) transmitting a signal for linking a first device represented by the selected first item and a second device represented by the selected second item, with each other, based on the detecting of:
a) the selection of the first item, and
b) the selection of the second item,
wherein the selected first and second items being in spatial alignment with each other on the display provides an indication of the linking of the first and second devices.

11. The system of claim 10 further comprising the first and second devices, wherein the first device and the second device are in communication with each other as a result of the transmitting of the signal for linking.

12. The system of claim 11 wherein the first device is a sensor.

13. The system of claim 12 wherein the second device is an actor that is configured to perform an action based on a signal from the sensor.

14. The system of claim 10 wherein the displaying of the at least one item in the first series of items comprises displaying, on the display, a candidate item with a different emphasis than that of any other items in the first series that are displayed on the display.

15. The system of claim 10 wherein the detecting of the selection of the first item comprises determining whether the first item has been moved, by a user of the display, to within a first display region on the display.

16. The system of claim 15 wherein the detecting of the selection of the second item comprises determining whether the second item has been moved to within a second display region on the display, wherein the first and second display regions are in spatially aligned with each other in relation to the spatial dimensions of the display.

17. The system of claim 10 wherein
i) the display is also for displaying one or more choices in a third region of the display, each choice in the one or more choices offering user-selectable options, wherein the one or more choices displayed are based on a combination of the selected first and second items;
ii) the processor is also for detecting a selection of at least one option from the user-selectable options; and
iii) the transmitting of the signal for linking is also based on the selection of the at least one option

18. The system of claim 10 wherein the second series of items comprises at least one item that is representative of an advertisement that is based on the selected first item.

19. A method comprising:
displaying at least one cause in a displayable series of causes, on a display;
detecting a selection of a cause from the series of causes;
displaying at least one effect in a displayable series of effects, on the display, wherein the series of effects is based on the selected cause;
detecting a selection of an effect from the series of effects; and
transmitting a signal for linking a) a first device that is capable of monitoring for the cause selected and b) a second device that is capable of implementing the effect selected, with each other, such that the selected effect is brought about when the selected cause occurs, wherein the linking is based on the detecting of:
i) the selection of the cause, and
ii) the selection of the effect.

20. The method of claim 19 wherein the selected cause and selected effect being in spatial alignment with each other on the display provides an indication of the linking of the first and second devices.

21. The method of claim 19 wherein the selected cause is representative of a sensor device and the selected effect is representative of an actor device.

22. The method of claim 19 further comprising:
i) displaying one or more choices on the display, each choice in the one or more choices offering user-selectable options, wherein the one or more choices displayed are based on a combination of the selected cause and the selected effect; and
ii) detecting a selection of at least one option from the user-selectable options;
wherein the transmitting of the signal for linking is also based on the selection of the at least one option.
